(19) United States
(12) Patent Application Publication
(10) Pub. No.: US 2025/0218062 A1
(43) Pub. Date: Jul. 3, 2025

(54) IMAGE GENERATION USING ORGANIC PROPERTIES

(71) Applicant: Shutterstock, Inc., New York, NY (US)

(72) Inventors: Raúl Gómez Bruballa, Dublin (IE); Alessandra Sala, Dublin (IE)

(21) Appl. No.: 19/005,148

(22) Filed: Dec. 30, 2024

Related U.S. Application Data
(60) Provisional application No. 63/615,426, filed on Dec. 28, 2023.

(51) Int. Cl. G06T 11/00; G06V 10/774; G06V 10/82

(52) U.S. Cl. CPC G06T 11/00; G06V 10/774; G06V 10/82

(57) ABSTRACT

A method for training an image generation model includes receiving training data having multiple training images, image captions corresponding to the training images, and corresponding image features, each training image associated with one image caption and one or more image features. The method further includes performing a training process to condition the image generation model using the training images, the image captions, and the image features, resulting in a trained model that generates images conditioned to the image features. The image features include image properties that are extracted from pixels or regions of each training image and camera properties that are associated with each training image.

### CROSS-REFERENCE OF RELATED APPLICATION

This application claims the benefit of U.S. Provisional Application No. 63/615,426, filed on Dec. 28, 2023, and which is incorporated herein in its entirety.

### TECHNICAL FIELD

The present disclosure generally relates to image generation, and more particularly to image generation using organic image properties.

### BACKGROUND

Generative artificial intelligence (AI) has been used for image generation using a text-based prompt. However, during training of the AI model, reconstruction loss may be high due to image differences between the training images and the generated output.

As such, there is a need for reducing reconstruction loss to improve the training process of AI models and the quality of output images that are generated using these AI models.

### SUMMARY

Some embodiments of the present disclosure provide a method for training an image generation model. The method includes receiving training data having a group of training images, a group of image captions corresponding to the group of training images, and a corresponding group of image features, each training image associated with one image caption and further associated with one or more image features. The method further includes performing a training process to condition the image generation model using the group of training images, the group of image captions, and the group of image features, resulting in a trained model that generates images conditioned to the group of image features. In some embodiments, the image features include a group of image properties that are extracted from pixels or regions of each training image and a group of camera properties that are associated with each training image.

Some embodiments of the present disclosure provide a non-transitory computer-readable medium storing a program for training an image generation model. The program, when executed by a computer, configures the computer to receive training data having a group of training images, a group of image captions corresponding to the group of training images, and a corresponding group of image features, each training image associated with one image caption and further associated with one or more image features. The program, when executed by a computer, further configures the computer to perform a training process to condition the image generation model using the group of training images, the group of image captions, and the group of image features, resulting in a trained model that generates images conditioned to the group of image features. In some embodiments, the image features include a group of image properties that are extracted from pixels or regions of each training image and a group of camera properties that are associated with each training image.

Some embodiments of the present disclosure provide a system for training an image generation model. The system comprises a processor and a non-transitory computer readable medium storing a set of instructions, which when executed by the processor, configure the processor to receive training data having a group of training images, a group of image captions corresponding to the group of training images, and a corresponding group of image features, each training image associated with one image caption and further associated with one or more image features. The instructions, when executed by the processor, further configure the computer to perform a training process to condition the image generation model using the group of training images, the group of image captions, and the group of image features, resulting in a trained model that generates images conditioned to the group of image features. In some embodiments, the image features include a group of image properties that are extracted from pixels or regions of each training image and a group of camera properties that are associated with each training image.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement image generation, according to some embodiments.

FIG. 2 is a block diagram illustrating details of a system for image generation, according to some embodiments.

FIG. 3A illustrates an image acquisition and feature extraction pipeline of some embodiments.

FIG. 3B illustrates a feature selection and processing pipeline of some embodiments.

FIG. 3C illustrates training of an image generation model that leverages organic properties, according to some embodiments.

FIG. 3D illustrates an inference example of some embodiments.

FIG. 4A shows an example of training an image generation model without organic properties conditioning, according to some embodiments.

FIG. 4B shows an example of training an image generation model with organic properties conditioning, according to some embodiments.

FIG. 5A, FIG. 5B, FIG. 5C, and FIG. 5D show examples of how providing different organic properties results in different outputs, according to some embodiments.

FIG. 6 is a flowchart illustrating a process for training an image generation model, according to some embodiments.

FIG. 7 is a block diagram illustrating an exemplary computer system with which aspects of the subject technology can be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The term “image generation model” as used herein refers, in some embodiments, to artificial intelligence-based (AI) and/or machine learning (ML) models designed to generate image output based on text, image, audio, video, or other digital media inputs. These models employ various techniques including, but not limited to, diffusion models, latent diffusion models, generative adversarial networks (GANs), variational autoencoders (VAEs), autoregressive models, and transformer-based architectures. The terms “image generator” and “generative image model” may be used equivalently herein to refer to image generation models. As used herein, image generation models are also understood by persons of ordinary skill in the art to include video generative models that generate video output.

The term “loss function” as used herein refers, according to some embodiments, to mathematical functions that are used in the training of image generation models. These functions quantify the discrepancy between the model's predictions and the ground truth (i.e., the training data) to guide an iterative optimization process, enabling the trained model to generate accurate and diverse output images. Examples of loss functions for image generation models include, but are not limited to, mean squared error (MSE), cross-entropy, Wasserstein distance, and Kullback-Leibler (KL) divergence.

The term “reconstruction loss” may be used herein to refer to the discrepancy between the model's predictions and the ground truth during a single iteration of the training process.

The term “optimization loss” as used herein refers, according to some embodiments, to an overall objective of minimizing the discrepancy being measured by the loss function to improve the model's performance. In other words, the loss function evaluates individual predictions and guiding model adjustments, and the optimization loss seeks to minimize error across the entire training dataset, by iteratively adjusting model parameters during training.

Text-to-image models may be conditioned to different information instead of or combined with text. Examples of conditioning text-to-image models to additional information (equivalently referred to as “micro-conditioning”) is provided in U.S. Patent No. 12,106,548 (“Balanced Generative Image Model Training”) issued on Oct. 1, 2024, and incorporated herein by reference, and also provided in pending U.S. Application No. 18/638,17 (“Moderated Generative Image Model Training”) filed on Apr. 17, 2024, and incorporated herein by reference.

All references cited anywhere in this specification, including the Background and Detailed Description sections, are incorporated by reference as if each had been individually incorporated.

Some embodiments provide an image generation model that is able to generate images with user-specified desired organic properties, where organic properties include camera settings used to capture the images, as well as image properties extracted from the pixels of the image. The terms “settings,” “features,” and “properties” are used equivalently herein.

In some embodiments, during training, the image generation model may be conditioned to a textual image caption (or different information in other embodiments) and additionally to image organic properties. Therefore, the image generation model learns to generate images based on a given input prompt (or other information) and with certain image organic properties.

In some embodiments, during inference, a user may select the desired organic properties of the generated images. As a non-limiting example, just as a photographer sets up the shutter speed of his camera to control the time its sensor gets exposed to light, a user of the image generation model of some embodiments can set up the target shutter speed to achieve a similar effect in the generated images.

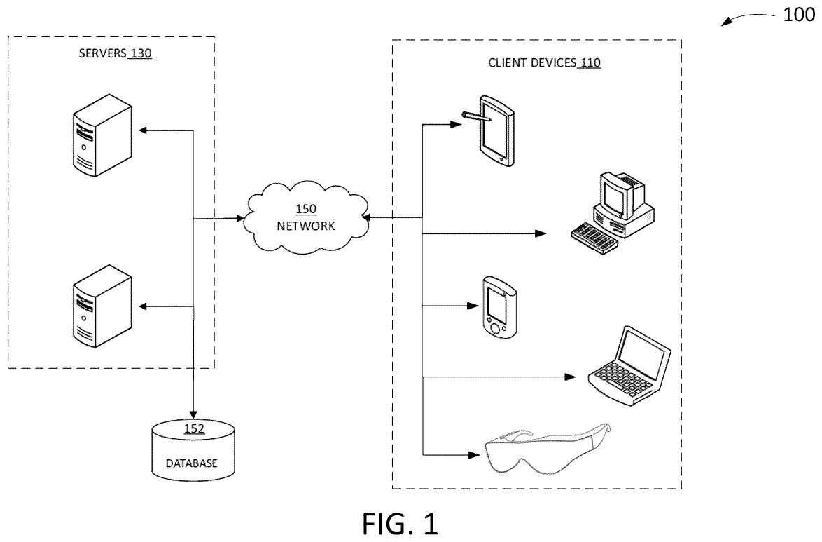

FIG. 1 illustrates a network architecture 100 used to implement image generation, according to some embodiments. The network architecture 100 may include one or more client devices 110 and servers 130, communicatively coupled via a network 150 with each other and to at least one database, e.g., database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

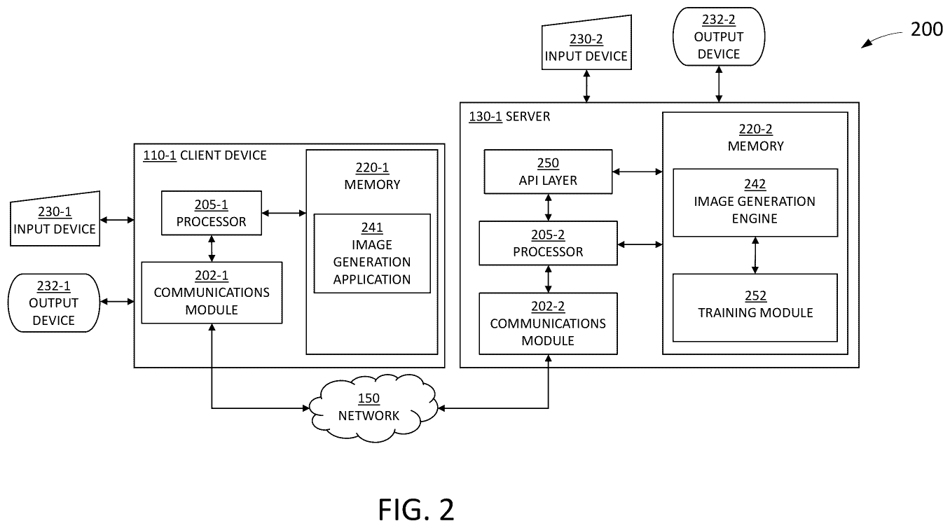

FIG. 2 is a block diagram illustrating details of a system 200 for image generation, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include processors 205-1 and 205-2 and memories 220-1 and 220-2, respectively. Processors 205-1 and 205-2 and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232. In some embodiments, the processor 205-1 is configured to control a graphical user interface (GUI) spanning at least a portion of input devices 230 and output devices 232, for the user of client device 110-1 to access the server 130-1.

Memory 220-1 may further include an image generation application 241, configured to execute on client device 110-1 and couple with input device 230-1 and output device 232-1. The image generation application 241 may be downloaded by the user from server 130-1, and/or may be hosted by server 130-1. The image generation application 241 may include specific instructions which, when executed by processor 205-1, cause operations to be performed consistent with embodiments of the present disclosure. In some embodiments, the image generation application 241 runs on an operating system (OS) installed in client device 110-1. In some embodiments, image generation application 241 may run within a web browser.

In some embodiments, memory 220-2 includes an image generation engine 242. The image generation engine 242 may include one or more image generation models that may be configured to perform methods and operations consistent with embodiments of the present disclosure. The image generation engine 242 may share or provide features and resources with the client device 110-1, including data, libraries, and/or applications retrieved with image generation engine 242 (e.g., image generation application 241). The user may access the image generation engine 242 through the image generation application 241. The image generation application 241 may be installed in client device 110-1 by the image generation engine 242 and/or may execute scripts, routines, programs, applications, generative image models, and the like provided by the image generation engine 242. In some embodiments, image generation application 241 may communicate with image generation engine 242 through an API layer 250.

In some embodiments, memory 220-2 includes training module 252. The training module 252 may be configured to perform methods and operations consistent with embodiments of the present disclosure. For example, training module 252 may perform a training process on one or more image generation models executed by the image generation engine 242. The training module 252 may use training data (not shown) either stored in memory 220-2 or retrieved from an external database (e.g., database 152) to perform the training process on the image generation models.

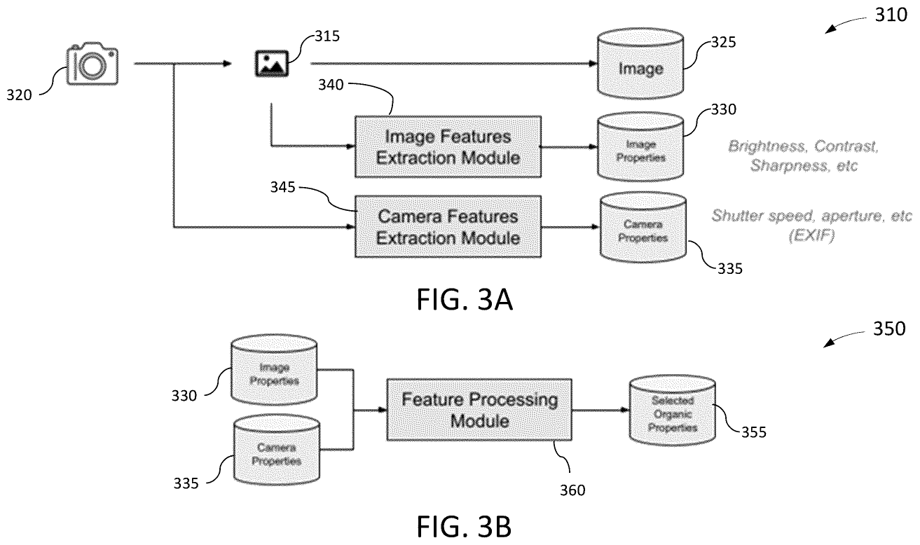

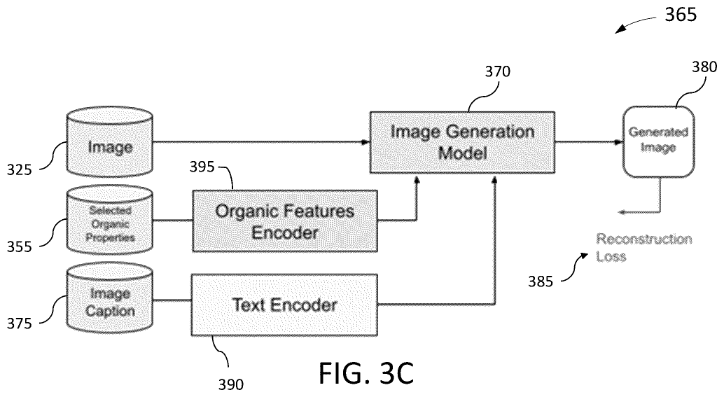

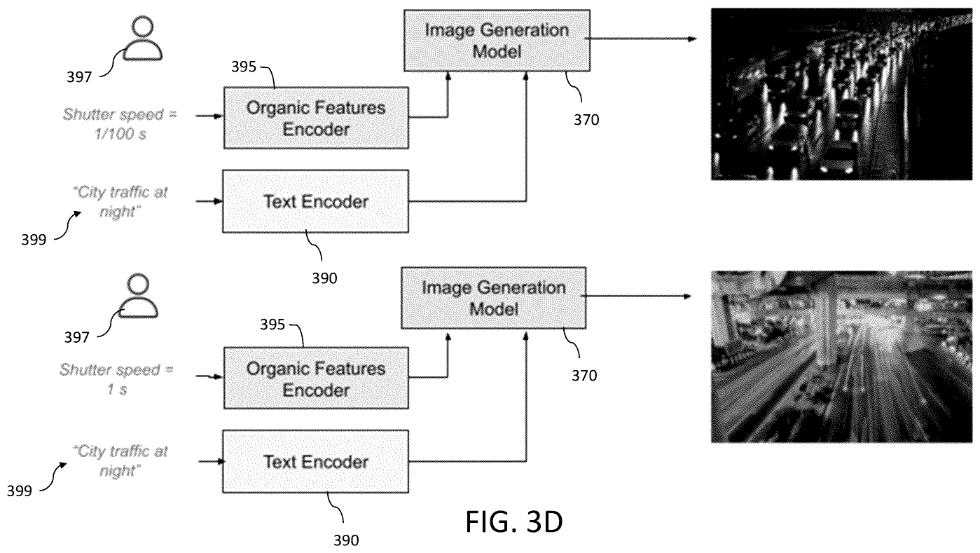

FIGS. 3A to 3D illustrate various stages of training of an image generation model and inference using the trained image generation model, according to some embodiments. In various embodiments, one or more of these stages may be combined or omitted.

FIG. 3A illustrates an image acquisition and feature extraction pipeline 310 of some embodiments. The stage receives image data 315, which in this example is provided from a camera 320. Images 325 are extracted from the image data 315. In addition, image features of interest, equivalently referred to as image features, organic features, or organic properties, may be extracted from the image data 315 and saved at an image capture time or in a posterior process. The organic properties may include, but are not limited to, image properties 330 and camera properties 335.

In this example, an Image Features Extraction Module 340 extracts and saves the image properties 330. These image properties 330 may be organic properties that can be directly extracted from pixels or regions of each image, such as (but not limited to) saturation, brightness, sharpness, and contrast.

In this example, a Camera Features Extraction module 345 extracts and saves the camera properties 335. These camera properties may be organic properties that contain information around the image capture setup. For example, such information may be saved in the image file (e.g., in a metadata format, such as an EXIF format). Camera properties may include, but are not limited to, acquisition parameters such as shutter speed, focal length, field of view, aperture, ISO, lens information, and camera manufacturer and model.

FIG. 3B illustrates a feature selection and processing pipeline 350 of some embodiments. In this stage, a subset of the image properties 330 and/or camera properties 335 that were saved in stage 1 are selected as organic properties 355 to be leveraged for image generation.

In this example, a Feature Processing Module 360 performs the feature selection, and may also apply custom transformations to the selected features, such as but not limited to normalizations, whitening, categorizations, or cleaning. The Feature Processing Module 360 may also compute new organic properties based on combinations of existing organic features or settings. As an example, the Feature Processing Module 360 may compute an image noise ratio based on the camera ISO and the image sharpness.

FIG. 3C illustrates a training pipeline 365 of an image generation model 370 that leverages organic properties 355 (image features and camera features alike), according to some embodiments.

In some embodiments, the training may be conditioned to textual image captions 375. In other embodiments the image generator might be trained to generate images leveraging organic properties and conditioned to a different input other than text, such as image edges, or a target image (in an image translation setup).

As an example of an image translation setup, according to some embodiments, a photographer may take a photo with a given shutter speed, and then with the image generation model, translate that same image to a domain with a different shutter speed, and end up with an image they would have acquired had they setup the shutter speed of the camera differently.

Image generators conditioned to text may be trained by feeding a target image (also referred to as a “ground truth” image), an associated caption, and optimizing them to generate the target image given the caption. The example of FIG. 3C illustrates a training pipeline 365 that, in addition to the target images 325 and the associated captions 375, additionally feeds image organic properties 355 to the image generation model 370. In this example, the image generation model 370 is optimized to generate image(s) 380 given the associated captions 375 and the organic properties 355.

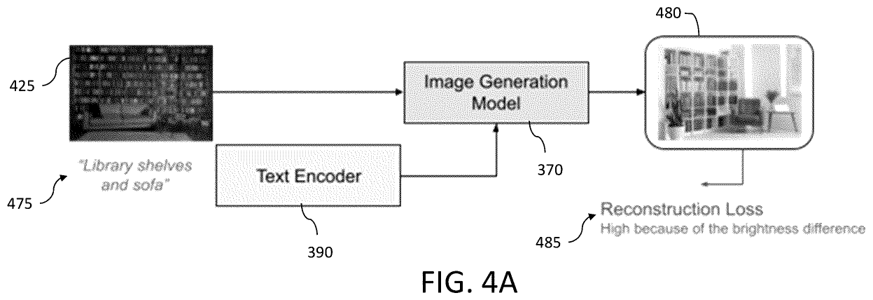

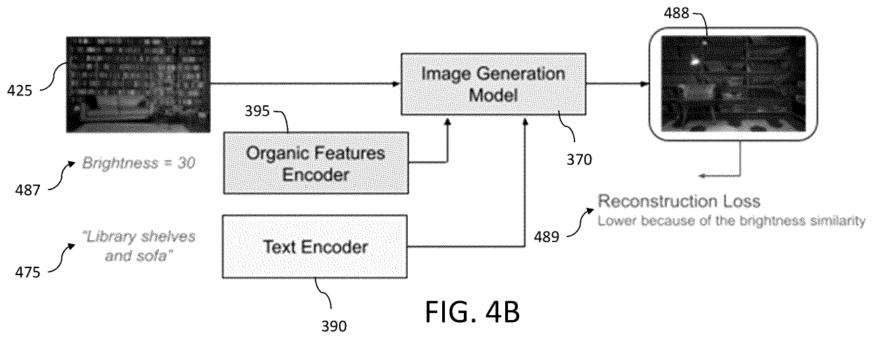

During training, a generative model conditioned to organic properties can learn which features are useful to reconstruct the training image, by learning an attention to them. Using organic properties as conditioning can help learning to reconstruct the image from the conditioning information faster, therefore optimizing the image generator model faster. As an example, image brightness is a proxy of how big the magnitudes of the generated image should be, so using brightness as a feature for conditioning may lead to a smaller and less noisy reconstruction loss, resulting in a smoother and faster training, as described in the example of FIG. 4 below.

A reconstruction loss 385 may be calculated by various methods corresponding to the image generation model 370, including but not limited to image subtraction in pixel space, a vector difference in a vector representation space, and a matrix difference. The training process optimizes the image generation model 370 to generate target images 380 based on an image prompt (corresponding to image captions such as image caption 375). In some embodiments, the image generation model 370 may be conditioned on different types of information, i.e., a sketch, another image, etc., during the current training process, an earlier training process, or combination thereof.

During training, the conditioning to the textual captions 375 (or any other info) and the organic properties 355 can be implemented in a number of different ways. In some embodiments, as illustrated with the example of FIG. 3C, the image captions 375 may be embedded using a Text Encoder 390. The organic properties 355 may be encoded by an Organic Features Encoder 395 that prepares the organic properties 355 to be consumed by the image generation model 370. Therefore, the image generation model 370 may receive two separate inputs, one for each conditioning type. In other embodiments, the organic properties 355 may be encoded as text, and the Text Encoder 390 may encode the image captions 375 and the organic properties 355 together.

The resulting trained image generation model 370 resulting from the training pipeline 365 can generate output images fitting input prompts and specified organic properties.

FIG. 3D illustrates an inference example of some embodiments, where a user 397 generates two images with the same input prompt 399 (“City traffic at night”) but using two different shutter speeds ( 1/100 sec and 1 sec). The impact of selecting the generator target shutter speed is similar to the impact of setting up the camera shutter speed to capture a scene.

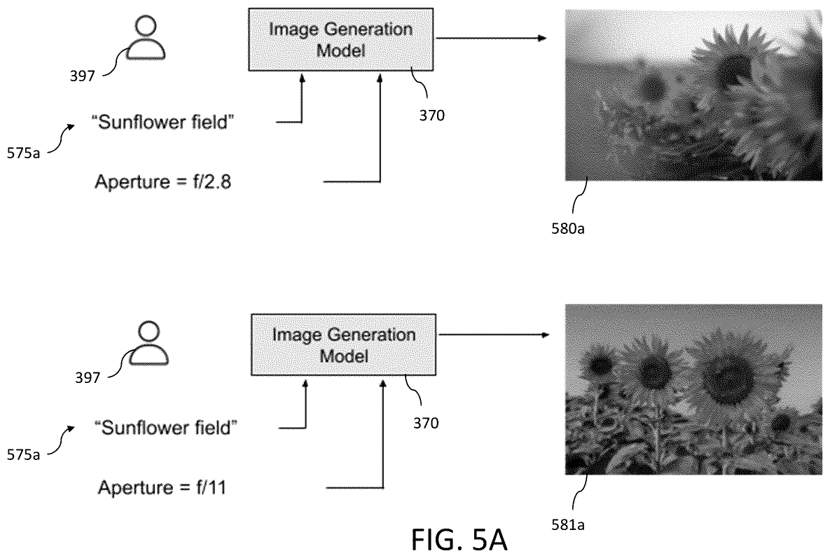

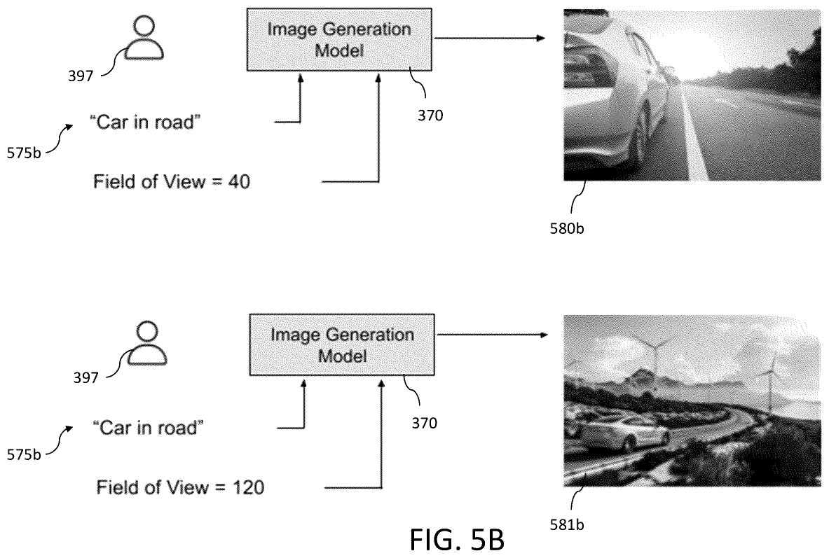

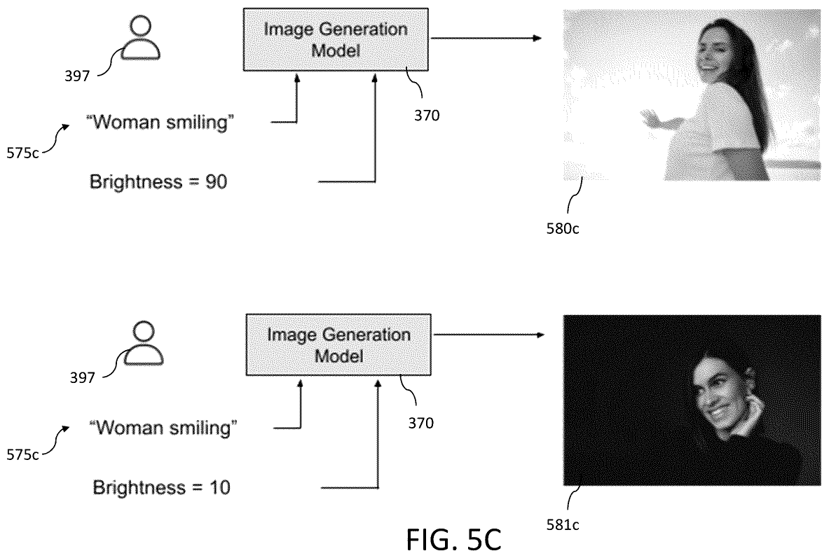

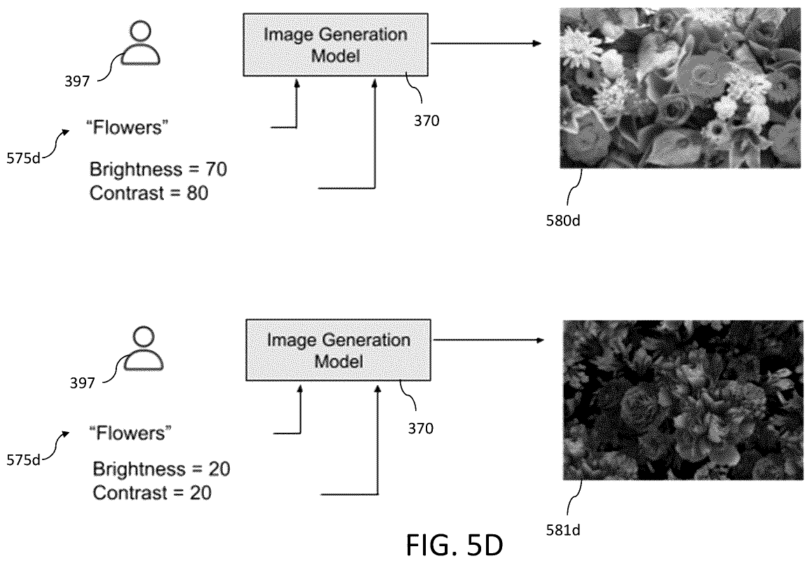

In the example of FIG. 3D, the user selects two different shutter speed values for the generation. In practice, the user may select any value of any organic properties (image properties and/or camera properties), and any combination or range of values. Other examples are shown in FIGS. 5A to 5D, which are described below.

As noted above, FIG. 3D shows an example of an embodiment where the user inputs a prompt and the desired organic properties. However, in other embodiments, the inference setup may be different, and the target organic properties may be provided from another source, such as (but not limited to) being selected in the backend. As an example, an image generator may be setup to generate multiple different output images for a given prompt, each output image having a different shutter speed value.

FIGS. 4A and 4B show an example of training an image generation model 370, both without organic properties conditioning (as shown in FIG. 4A) and with organic properties conditioning (as shown in FIG. 4B), according to some embodiments. The embodiments shown in FIGS. 4A and 4B are similar to the embodiments discussed above with respect to FIGS. 3A-3D, and like reference numerals have been used wherever possible to refer to the same or similar components. A detailed description of some such components will be omitted, and the following discussion focuses on the differences between these embodiments. Any of the various features discussed with any one of the embodiments discussed herein may also apply to and be used with any other embodiments.

In the examples of FIGS. 4A and 4B, the same training image 425 is used in both cases. Without conditioning, as in FIG. 4A, the same textual caption 475 (in this example, “library shelves and sofa”) associated with training image 425 results in an output image 480 with higher brightness than the training image 425. The reconstruction loss 485 is accordingly high because of the high brightness difference.

With conditioning, as in FIG. 4B, the organic features encoder 395 is also provided information 487 about the brightness of the training image (“brightness=30”) along with the same textual caption 475 (“library shelves and sofa”). With both inputs, the image generation model 370 outputs an image 488 with lower reconstruction loss 489 because of the brightness similarity of the output. In other words, the output image 488 is closer to the “ground truth” training image 425, i.e., has smaller error.

FIGS. 5A-5D show examples of how providing different organic properties results in different outputs, according to some embodiments. The embodiments shown in FIGS. 5A-5D are similar to the embodiments discussed above with respect to FIGS. 3A-3D and FIGS. 4A and 4B, and like reference numerals have been used wherever possible to refer to the same or similar components. A detailed description of some such components will be omitted, and the following discussion focuses on the differences between these embodiments. Any of the various features discussed with any one of the embodiments discussed herein may also apply to and be used with any other embodiments.

FIG. 5A shows results for a user 397 providing to the image generation model 370 a same prompt 575a, “sunflower field” with two different values for aperture, f/2.8 and f/11. The output images 580a, 581a depict scenes corresponding to the prompt 575a, but with different image characteristics corresponding to the different desired apertures.

FIG. 5B shows results for a user 397 providing to the image generation model 370 a same prompt 575b, “car in road” with two different values for field of view, 40 degrees and 120 degrees. The output images 580b, 581b depict scenes corresponding to the prompt 575b, but with different image characteristics corresponding to the different desired fields of view.

FIG. 5C shows results for a user 397 providing to the image generation model 370 a same prompt 575c, “woman smiling” with two different values of brightness, 90 and 10. The output images 580c, 581c depict scenes corresponding to the prompt 575c, but with different image characteristics corresponding to the different desired brightnesses.

FIG. 5D shows results for a user 397 providing to the image generation model 370 a same prompt 575d, “flowers” with two different sets of features, the first with brightness of 70 and contrast of 80, the second with brightness of 20 and contrast of 20. The output images 580d, 581d depict scenes corresponding to the prompt 575d, but with different image characteristics corresponding to the different desired brightnesses and contrasts.

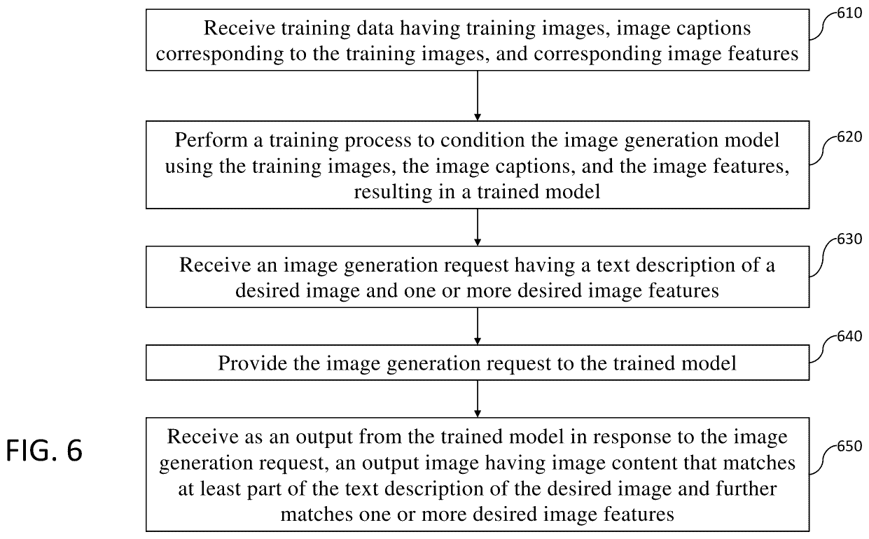

FIG. 6 is a flowchart illustrating a process 600 for training an image generation model performed by a client device (e.g., client device 110-1, etc.) and/or a client server (e.g., server 130-1, etc.), according to some embodiments. In some embodiments, one or more operations in process 600 may be performed by a processor circuit (e.g., processors 205, etc.) executing instructions stored in a memory circuit (e.g., memories 220, etc.) of a system (e.g., system 200, etc.) as disclosed herein. For example, operations in process 600 may be performed by image generation application 241, image generation engine 242, training module 252, or some combination thereof. Moreover, in some embodiments, a process consistent with this disclosure may include at least operations in process 600 performed in a different order, simultaneously, quasi-simultaneously, or overlapping in time.

In some embodiments, the image generation model is one of a Generative Adversarial Network (GAN), a Variational Autoencoder (VAE), an autoregressive model, a diffusion model, and a transformer-based architecture.

At 610, the process 600 includes receiving training data having training images, image captions corresponding to the training images, and corresponding image features, each training image associated with one image caption and further associated with one or more image features.

In some embodiments, the image features include image properties that are extracted from pixels or regions of each training image and camera properties that are associated with each training image. For example, the image properties may include, but are not limited to, saturation, brightness, sharpness, and contrast. The camera properties may include, but are not limited to, shutter speed, focal length, field of view, aperture, ISO, lens specifications, camera manufacturer, and camera model. In some embodiments, the image features include at least one parameter that is computed from one or more other image features.

In some embodiments, each training image has a corresponding image caption and/or at least one corresponding image feature stored as a metadata tag.

At 620, the process 600 includes performing a training process to condition the image generation model using the training images, the image captions, and the image features, resulting in a trained model that generates images conditioned to the image features.

In some embodiments, performing the training process includes providing the training data as an input to the image generation model, receiving output image data from the image generation model, using a loss function to compute a loss based on the output image data and the training data, and using the loss, optimizing the image generation model to generate images conditioned to the image features.

At 630, the process 600 includes receiving an image generation request having a text description of a desired image and one or more desired image features.

At 640, the process 600 includes providing the image generation request to the trained model.

At 650, the process 600 includes receiving as an output from the trained model in response to the image generation request, an output image having image content that matches at least part of the text description of the desired image and further matches the one or more desired image features.

In some embodiments, the process 600 further includes receiving an image generation request having an input image acquired using a first acquisition parameter and further having a desired second acquisition parameter, the input image being visually characterized by the first acquisition parameter and visually representing a particular image content. The process 600 provides the image generation request to the trained model, and receives as an output from the trained model in response to the image generation request, an output image that is visually characterized by the desired second acquisition parameter and still visually represents the same image content.

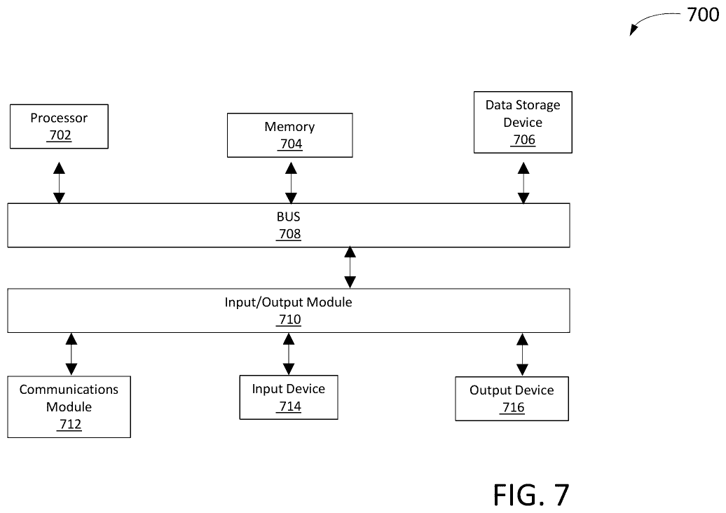

FIG. 7 is a block diagram illustrating an exemplary computer system 700 with which aspects of the subject technology can be implemented. In certain aspects, the computer system 700 may be implemented using hardware or a combination of software and hardware, either in a dedicated server, integrated into another entity, or distributed across multiple entities. As a non-limiting example, the computer system 700 may be one or more of the servers 130 and/or the client devices 110.

Computer system 700 includes a bus 708 or other communication mechanism for communicating information, and a processor 702 coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, i.e., one or more modules of computer program instructions encoded on a computer-readable medium for execution by, or to control the operation of, the computer system 700, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via input/output module 710 to various devices. The input/output module 710 can be any input/output module. Exemplary input/output modules 710 include data ports such as USB ports. The input/output module 710 is configured to connect to a communications module 712. Exemplary communications modules 712 include networking interface cards, such as Ethernet cards and modems. In certain aspects, the input/output module 710 is configured to connect to a plurality of devices, such as an input device 714 and/or an output device 716. Exemplary input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 716 include display devices such as an LCD (liquid crystal display) monitor, for displaying information to the user.

Some of the above-described embodiments may be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in the main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires that comprise bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 700 reads application data and provides an application, information may be read from the application data and stored in a memory device, such as the memory 704. Additionally, data from the memory 704 servers accessed via a network, the bus 708, or the data storage 706 may be read and loaded into the memory 704. Although data is described as being found in the memory 704, it will be understood that data does not have to be stored in the memory 704 and may be stored in other memory accessible to the processor 702 or distributed among several media, such as the data storage 706.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In some embodiments, the computer-readable media is non-transitory computer-readable media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A method for training an image generation model, comprising:
receiving training data comprising a plurality of training images, a plurality of image captions corresponding to the plurality of training images, and a corresponding plurality of image features, each training image associated with one image caption and further associated with one or more image features; and
performing a training process to condition the image generation model using the plurality of training images, the plurality of image captions, and the plurality of image features, resulting in a trained model that generates images conditioned to the plurality of image features,
wherein the image features comprise a plurality of image properties that are extracted from pixels or regions of each training image and a plurality of camera properties that are associated with each training image.

2. The method of claim 1, wherein the plurality of image properties comprise saturation, brightness, sharpness, and contrast.

3. The method of claim 1, wherein the plurality of camera properties comprise shutter speed, focal length, field of view, aperture, ISO, lens specifications, camera manufacturer, and camera model.

4. The method of claim 1, wherein the image features comprise a parameter that is computed from one or more other image features.

5. The method of claim 1, further comprising:
receiving an image generation request comprising a text description of a desired image and a desired image feature;
providing the image generation request to the trained model; and
receiving as an output from the trained model in response to the image generation request, an output image that comprises image content that matches at least part of the text description of the desired image and further matches the desired image feature.

6. The method of claim 5, wherein the desired image feature is a first desired image feature, the image generation request comprises a second desired image feature, and the image content further matches the second desired image feature.

7. The method of claim 1, further comprising:
receiving an image generation request comprising an input image acquired using a first acquisition parameter and further comprising a desired second acquisition parameter, wherein the input image is visually characterized by the first acquisition parameter and comprises an image content;
providing the image generation request to the trained model; and
receiving as an output from the trained model in response to the image generation request, an output image that is visually characterized by the desired second acquisition parameter and comprises the image content.

8. The method of claim 1, wherein performing the training process comprises:
providing, as an input to the image generation model, the training data;
receiving, from the image generation model, output image data;
using a loss function, computing a loss based on the output image data and the training data; and
using the loss, optimizing the image generation model to generate images conditioned to the plurality of image features.

9. The method of claim 1, wherein a contribution of each training image in the plurality of training images to an optimization loss of the training process is based on a corresponding image caption and a corresponding image feature.

10. The method of claim 1, wherein each training image in the plurality of training images comprises a corresponding image caption stored as a metadata tag.

11. The method of claim 1, wherein each training image in the plurality of training images comprises a corresponding image feature stored as a metadata tag.

12. The method of claim 1, wherein the image generation model is one of a Generative Adversarial Network (GAN), a Variational Autoencoder (VAE), an autoregressive model, a diffusion model, and a transformer-based architecture.

13. A non-transitory computer-readable medium storing a program for training an image generation model, which when executed by a computer, configures the computer to:
receive training data comprising a plurality of training images, a plurality of image captions corresponding to the plurality of training images, and a corresponding plurality of image features, each training image associated with one image caption and further associated with one or more image features; and
perform a training process to condition the image generation model using the plurality of training images, the plurality of image captions, and the plurality of image features, resulting in a trained model that generates images conditioned to the plurality of image features,
wherein the image features comprise a plurality of image properties that are extracted from pixels or regions of each training image and a plurality of camera properties that are associated with each training image.

14. The non-transitory computer-readable medium of claim 13, wherein the plurality of image properties comprise saturation, brightness, sharpness, and contrast, and the plurality of camera properties comprise shutter speed, focal length, field of view, aperture, ISO, lens specifications, camera manufacturer, and camera model.

15. The non-transitory computer-readable medium of claim 13, wherein the image features comprise a parameter that is computed from one or more other image features.

16. The non-transitory computer-readable medium of claim 13, wherein the program, when executed by the computer, further configures the computer to:
receive an image generation request comprising a text description of a desired image and a desired image feature;
provide the image generation request to the trained model; and
receive as an output from the trained model in response to the image generation request, an output image that comprises image content that matches at least part of the text description of the desired image and further matches the desired image feature.

17. The non-transitory computer-readable medium of claim 13, wherein the program, when executed by the computer, further configures the computer to:
receive an image generation request comprising an input image acquired using a first acquisition parameter and further comprising a desired second acquisition parameter, wherein the input image is visually characterized by the first acquisition parameter and comprises an image content;
provide the image generation request to the trained model; and
receive as an output from the trained model in response to the image generation request, an output image that is visually characterized by the desired second acquisition parameter and comprises the image content.

18. A system for training an image generation model, comprising:
a processor; and
a non-transitory computer readable medium storing a set of instructions, which when executed by the processor, configure the system to:
receive training data comprising a plurality of training images, a plurality of image captions corresponding to the plurality of training images, and a corresponding plurality of image features, each training image associated with one image caption and further associated with one or more image features; and
perform a training process to condition the image generation model using the plurality of training images, the plurality of image captions, and the plurality of image features, resulting in a trained model that generates images conditioned to the plurality of image features,
wherein the image features comprise a plurality of image properties that are extracted from pixels or regions of each training image and a plurality of camera properties that are associated with each training image.

19. The system of claim 18, wherein the plurality of image properties comprise saturation, brightness, sharpness, and contrast, and the plurality of camera properties comprise shutter speed, focal length, field of view, aperture, ISO, lens specifications, camera manufacturer, and camera model.

20. The system of claim 18, wherein the instructions, when executed by the processor, further configure the system to:
receive an image generation request comprising a text description of a desired image and a desired image feature;
provide the image generation request to the trained model; and
receive as an output from the trained model in response to the image generation request, an output image that comprises image content that matches at least part of the text description of the desired image and further matches the desired image feature.
